(19) United States
(12) Patent Application Publication
(10) Pub. No.: US 2014/0169467 A1
(43) Pub. Date: Jun. 19, 2014

(54) VIDEO CODING INCLUDING SHARED MOTION ESTIMATION BETWEEN MULTPLE INDEPENDENT CODING STREAMS

(71) Applicants: Ce Wang, Bellevue, WA (US); Akshat Nanda, El Dorado Hills, CA (US)

(72) Inventors: Ce Wang, Bellevue, WA (US); Akshat Nanda, El Dorado Hills, CA (US)

(21) Appl. No.: 13/714,870

(22) Filed: Dec. 14, 2012

(51) Int. Cl. H04N 7/26

(52) U.S. Cl. CPC H04N 19/00587
USPC 375/240.16

(57) ABSTRACT

Systems, apparatus, articles, and methods are described including operations for shared motion estimation between multiple independent coding streams.

### BACKGROUND

Recently, with the technology advance and network bandwidth growth, demand on applications for video streaming and video conferencing has increased significantly. For example, it is reported that in 2011 traffic from Netflix already consisted of around 60% of all network data flow. Video streaming and video conferencing typically utilize video encoding from a same source into multiple streams with different resolutions, qualities and/or bit rates. As bandwidth conditions and decoding capability of multiple receiver clients often vary, different clients may not be able to consume same stream from a given source. The process of encoding the same source into multiple streams is often called a simulcast.

Current hardware accelerated simulcast implementations often encode each picture independently. The encoding is typically either performed through serial processes or parallel processes with minimal exchange of data between the processes.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of conventional coding system;

FIG. 2 is an illustrative diagram of an example video coding system;

FIG. 3 is an illustrative diagram of an example video coding system;

FIG. 4 is a flow chart illustrating an example video coding process;

FIG. 5 is an illustrative diagram of an example video coding process in operation;

FIG. 6 is an illustrative diagram of an example video coding system;

FIG. 7 is an illustrative diagram of an example system; and

FIG. 8 is an illustrative diagram of an example system, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

Systems, apparatus, articles, and methods are described below including operations for shared motion estimation between multiple independent coding streams.

As described above, in some cases, conventional hardware accelerated simulcast implementations often encode each picture independently. The encoding is typically either performed through serial processes or parallel processes with minimal exchange of data between the processes. Such processes may be inefficient as they may not leverage information created by a preceding encode process. Thus, such simulcast solutions may be limited in their throughput and power efficiency.

As will be described in greater detail below, operations for shared motion estimation between multiple independent coding streams may include a universal algorithm for hardware accelerated simulcast. This method utilizes an efficient information stream between various bitstream encode processes to increase the throughput of simulcast encoding and decrease the overall power usage at the same time. The algorithms presented here are general enough that can be applied on virtually any existing video codecs, such as Mpeg2, VC1, H.264-AVC/SVC, VP8, HEVC, the like, as well as possible future codec standards. What is more, since the current video codecs typically share the same basic coding components such as motion estimation, motion compensation, frequency domain transformation, entropy coding, etc., the techniques proposed herein may be applied to mixed codec encoding. For example, the techniques proposed herein may be applied to mixed codec encoding where the encoder may be operated to generate AVC and VP8 bitstreams simultaneously on the same source.

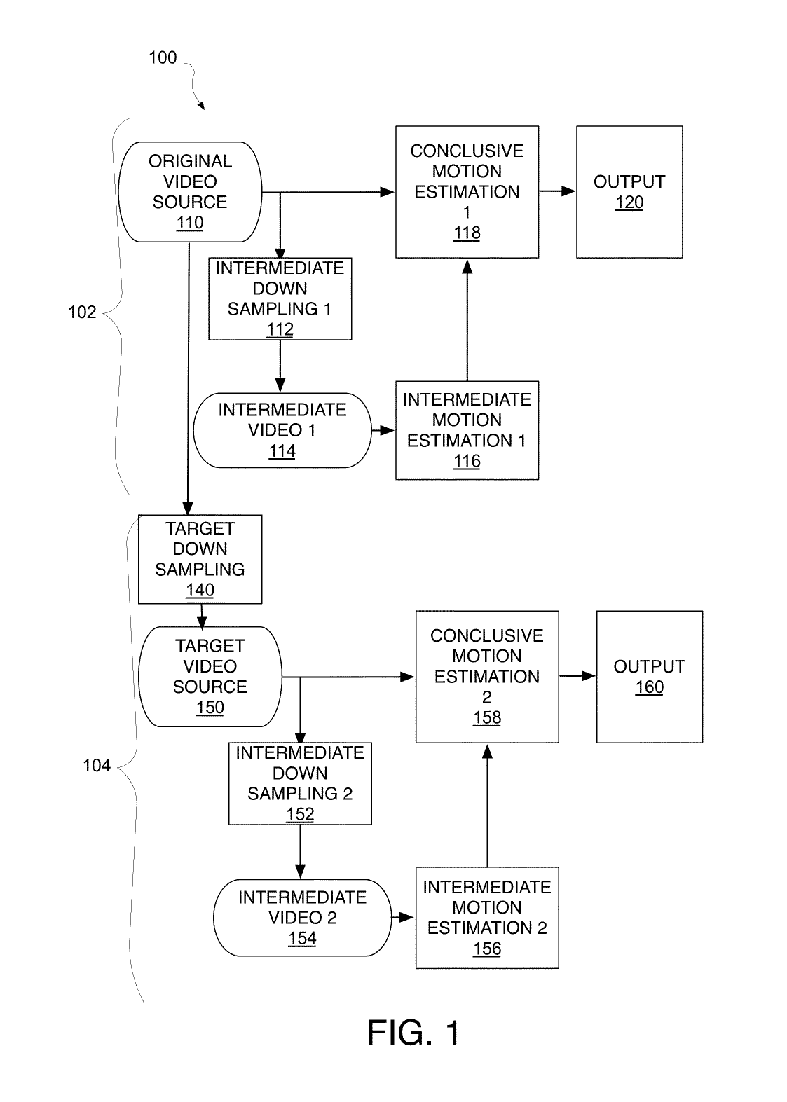

FIG. 1 is an illustrative diagram of conventional coding system 100. As illustrated, simulcast encoding may include a two-stream simulcast encoding process, with a first independent coding stream 102 and a second independent coding stream 104. An original video source 110 may be down sampled into an intermediate video 1 114 via intermediate down sampling 1 module 112. Intermediate motion estimation 1 module 116 may perform motion estimation based at least in part on the intermediate video 1 114 and output the results to a conclusive motion estimation 1 module 118. Conclusive motion estimation 1 module 118 may provide conclusive motion estimation to output module 120 based at least in part on the intermediate motion estimation from intermediate motion estimation 1 module 116 as well as original video source 110, each of which are completely isolated within the process for first independent coding stream 102.

Additionally, in second independent coding stream 104, original video source 110 may be down sampled into a target video source 150 via a target down sampling module 140. Target video source 150 may be down sampled into an intermediate video 2 154 via intermediate down sampling 2 module 152. Intermediate motion estimation 2 module 156 may perform motion estimation based at least in part on the intermediate video 2 154 and output the results to a conclusive motion estimation 2 module 158. Conclusive motion estimation 2 module 158 may provide conclusive motion estimation to output module 160 based at least in part on the intermediate motion estimation from intermediate motion estimation 2 module 156 as well as target video source 150. In operation, second independent coding stream 104 does not directly feed back motion estimation data to first independent coding stream 102.

As illustrated, conventional coding system 100 typically may include a two-stream simulcast encoding process. Each encoding has a two-layer hierarchical motion estimation process which contains a down sampling followed by motion estimation on a low resolution layer then motion estimation on original resolution layer. The source of the second stream encoding comes from the down-sampling from the original source.

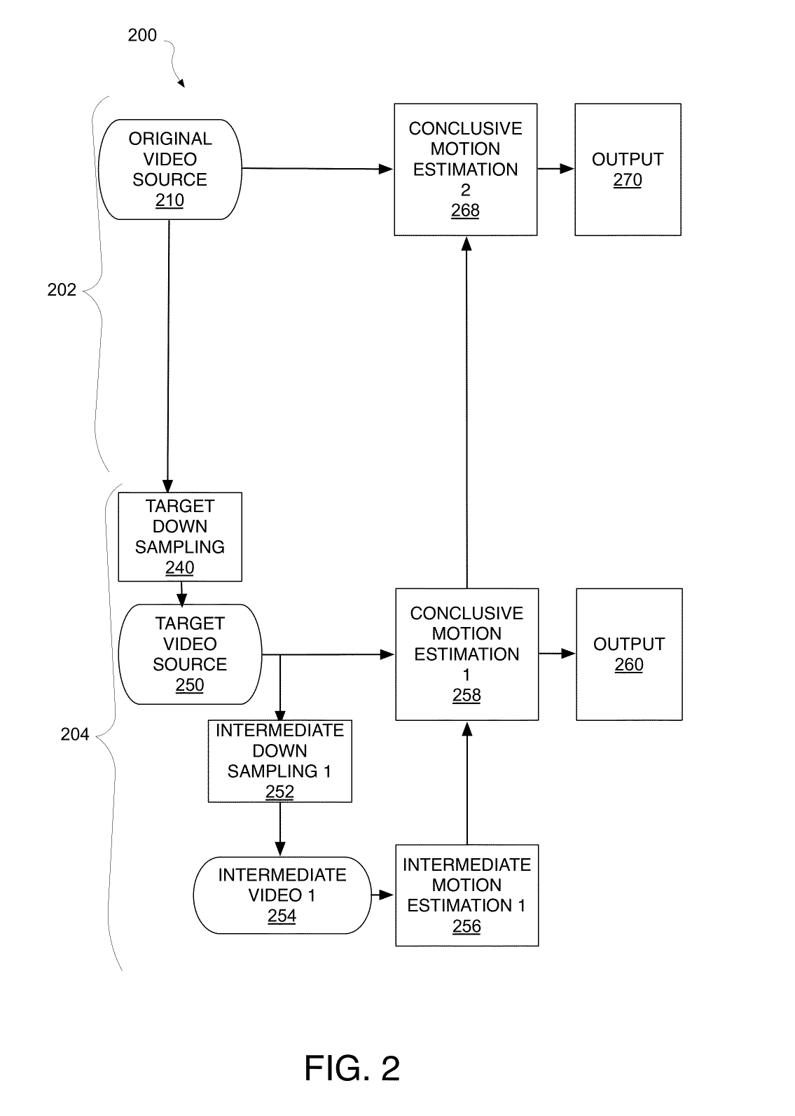

FIG. 2 is an illustrative diagram of an example video coding system 200, arranged in accordance with at least some implementations of the present disclosure. In the illustrated implementation, video coding system 200 may include additional items that have not been shown in FIG. 2 for the sake of clarity. For example, video coding system 200 may include a processor, a radio frequency-type (RF) transceiver, and/or an antenna. Further, video coding system 200 may include additional items such as a speaker, a microphone, an accelerometer, memory, a router, network interface logic, etc. that have not been shown in FIG. 2 for the sake of clarity.

As used herein, the term “coder” may refer to an encoder and/or a decoder. Similarly, as used herein, the term “coding” may refer to encoding via an encoder and/or decoding via a decoder.

Simulcast encoding usually includes a down-sampling process (not included for the stream of original resolution), followed by motion estimation, motion compensation, quantization and entropy coding, etc. procedures. Motion estimation algorithms often contain one or more layers of hierarchical motion search steps. Since motion estimation and downsampling are usually the most time consuming and power expensive procedures, these procedures are emphasized in the following diagram.

As illustrated, simulcast encoding may include a two-stream simulcast encoding process, with a first independent coding stream 202 and a second independent coding stream 204. The first independent coding stream 202 may be coded in accordance with a first coding standard, while second independent coding stream 204 may be coded in accordance with a second coding standard different from the first coding standard associated with first independent coding stream 202. In second independent coding stream 204, original video source 210 may be down sampled into a target video source 250 via a target down sampling module 240. Target video source 250 may be down sampled into an intermediate video 1 254 via intermediate down sampling 1 module 252. Intermediate motion estimation 1 module 256 may perform motion estimation based at least in part on the intermediate video 1 254 and output the results to a conclusive motion estimation 1 module 258. Conclusive motion estimation 1 module 258 may provide conclusive motion estimation to output module 260 based at least in part on the intermediate motion estimation from intermediate motion estimation 1 module 256 as well as target video source 250. In operation, second independent coding stream 204 directly feeds back motion estimation data to first independent coding stream 202.

In first independent coding stream 202, conclusive motion estimation 2 module 268 may provide conclusive motion estimation to output module 270 based at least in part on the motion estimation from conclusive motion estimation 1 module 258 associated with second independent coding stream 204 as well as original video source 210. Accordingly, second independent coding stream 204 directly feeds back motion estimation data to first independent coding stream 202.

In operation, a second motion logic module (e.g. conclusive motion estimation 1 module 258) may be configured to perform conclusive motion estimation of target video source 250 within second independent coding stream 204. The target video source 250 may be a down sampled version of original video source 210. Original video source 210 may be associated with first independent coding stream 202 and target video source 250 may be associated with second independent coding stream 204. A first motion logic module (e.g. conclusive motion estimation 2 module 268) may be configured to perform conclusive motion estimation for original video source 210 within first independent coding stream 202 based at least in part on the conclusive motion estimation of target video source 250 within second independent coding stream 204.

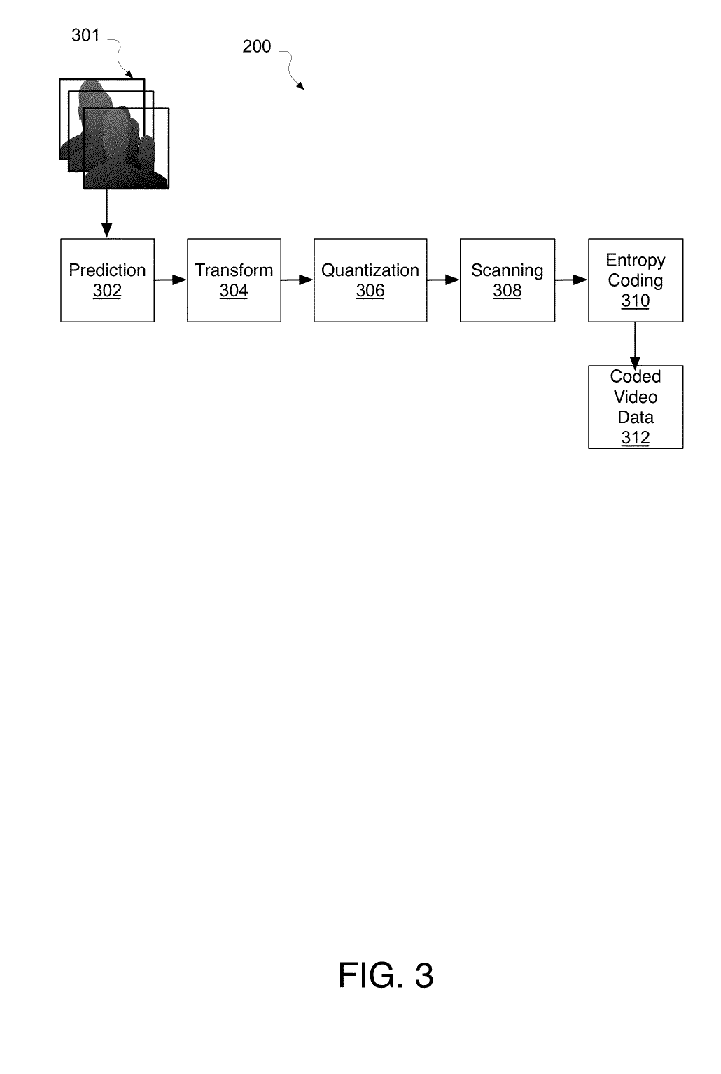

In some examples, one or more entropy coder modules (not shown, see for example, entropy coding module 310 of FIG. 3 below) may be communicatively coupled to first motion logic module (e.g. conclusive motion estimation 2 module 268) and the second logic module (e.g. conclusive motion estimation 1 module 258). Such entropy coder may be configured to code output 260 from second independent coding stream 204 for inclusion in a multi-stream simulcast to generate a coded second output from target video source 250 based at least in part on the performed conclusive motion estimation for the conclusive motion estimation of the target video source 250, and code output 270 from first independent coding stream 202 for inclusion in the multi-stream simulcast to generate a coded first output from original video source 210 based at least in part on the performed conclusive motion estimation for original video source 210.

In some examples, target down sampling logic module 240 of video coding system 200 may be configured to perform a target down sampling from original video source 210 to target video source 250 to provide target video source 250. The target down sampling may be performed prior to the performance of the conclusive motion estimation of the target video source 250. Intermediate down sampling logic module 252 may be communicatively coupled to target down sampling logic module 240 and may be configured to perform an intermediate down sampling from target video source 250 to an intermediate video 254. Intermediate motion logic module 256 may be communicatively coupled to intermediate down sampling logic module 252 and may be configured to perform an intermediate motion estimation based at least in part on the intermediate video 254. In some examples, the intermediate motion estimation may be performed only on full integer pixel point resolution of the intermediate video and not on a fractional pixel point resolution, for example.

In some examples, the conclusive motion estimation of target video source 210 performed during the coding of second independent coding stream 204 may be based at least in part on the intermediate motion estimation. Second coded output 260 may have the same resolution as first coded output 270 and a bandwidth requirement different from first coded output 270, or second coded output 260 may have a resolution different from first coded output 270 and the same bandwidth requirement as first coded output 270.

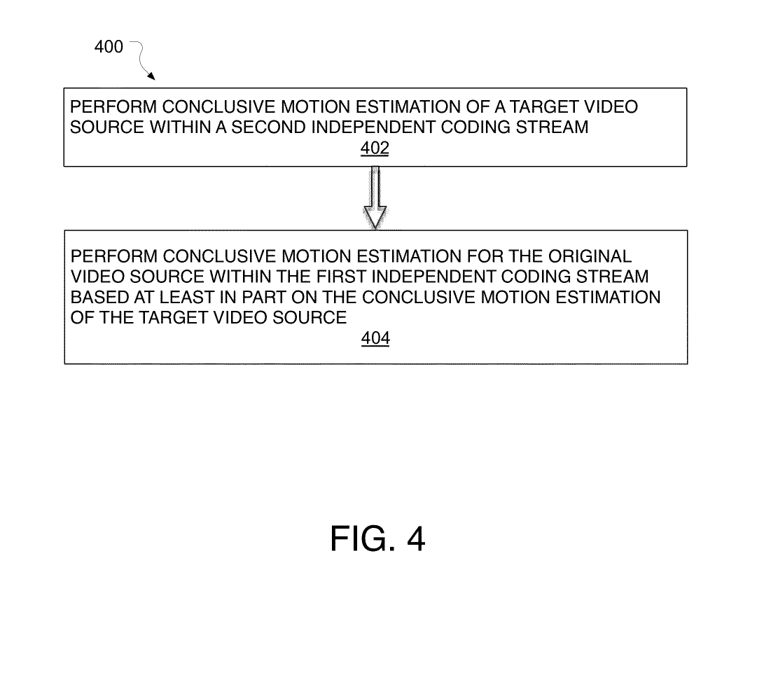

As will be discussed in greater detail below, video coding system 200 may be used to perform some or all of the various functions discussed below in connection with FIGS. 4 and/or 5.

FIG. 3 illustrates a high-level block diagram of an example video coding system 200 in accordance with the present disclosure. In various implementations, video coding system 200 may include a prediction module 302, a transform module 304, a quantization module 306, a scanning module 308, and an entropy encoding module 310. In various implementations, video coding system 300 may be configured to encode video data (e.g., in the form of video frames or pictures) according to various video coding standards and/or specifications, including, but not limited to, the High Efficient Video Coding (HEVC) video compression standard planned to be finalized by the end of 2012, MPEG2, VC1, H.264-AVC/svc, VP8, and/or the like. In the interest of clarity, the various devices, systems and processes are described are not limited to any particular video coding standards and/or specifications.

Prediction module 302 may perform spatial and/or temporal prediction using the input video data 301. For example, input video image frames may be decomposed into slices that are further sub-divided into macroblocks for the purposes of encoding. Prediction module 302 may apply known spatial (intra) prediction techniques and/or known temporal (inter) prediction techniques to predict macroblock data values.

Transform module 304 may then apply known transform techniques to the macroblocks to spatially decorrelate the macroblock data. Those of skill in the art may recognize that transform module 304 may first sub-divide 16×16 macroblocks into 4×4 or 8×8 blocks before applying appropriately sized transform matrices.

Quantization module 306 may then quantize the transform coefficients in response to a quantization control parameter that may be changed, for example, on a per-macroblock basis. For example, for 8-bit sample depth the quantization control parameter may have 52 possible values. In addition, the quantization step size may not be linearly related to the quantization control parameter.

Scanning module 308 may then scan the matrices of quantized transform coefficients using various known scan order schemes to generate a string of transform coefficient symbol elements. The transform coefficient symbol elements as well as additional syntax elements such as macroblock type, intra prediction modes, motion vectors, reference picture indexes, residual transform coefficients, and so forth may then be provided to entropy coding module 310, which may in turn output coded video data 312.

As will be discussed in greater detail below, video coding system 200, as described in FIGS. 2 and/or 3 may be used to perform some or all of the various functions discussed below in connection with FIGS. 4 and/or 5.

FIG. 4 is a flow chart illustrating an example video coding process 400, arranged in accordance with at least some implementations of the present disclosure. In the illustrated implementation, process 400 may include one or more operations, functions or actions as illustrated by one or more of blocks 402, and/or 404. By way of non-limiting example, process 400 will be described herein with reference to example video coding system 200 of FIG. 2, 3 and/or 6.

Process 400 may be utilized as a computer-implemented method for content aware selective adjusting of motion estimation. Process 400 may begin at block 402, “PERFORM CONCLUSIVE MOTION ESTIMATION OF A TARGET VIDEO SOURCE WITHIN A SECOND INDEPENDENT CODING STREAM”, where conclusive motion estimation of a target video source may be performed. For example, conclusive motion estimation of a target video source may be performed within a second independent coding stream, wherein the target video source may be a down sampled version of an original video source. The original video source may be associated with a first independent coding stream and the target video source may be associated with a second independent coding stream.

Processing may continue from operation 402 to operation 404, “PERFORM CONCLUSIVE MOTION ESTIMATION FOR THE ORIGINAL VIDEO SOURCE WITHIN THE FIRST INDEPENDENT CODING STREAM BASED AT LEAST IN PART ON THE CONCLUSIVE MOTION ESTIMATION OF THE TARGET VIDEO SOURCE”, where conclusive motion estimation of a the original video source may be performed. For example, conclusive motion estimation of a the original video source may be performed within the first independent coding stream based at least in part on the conclusive motion estimation of the target video source within the second independent coding stream.

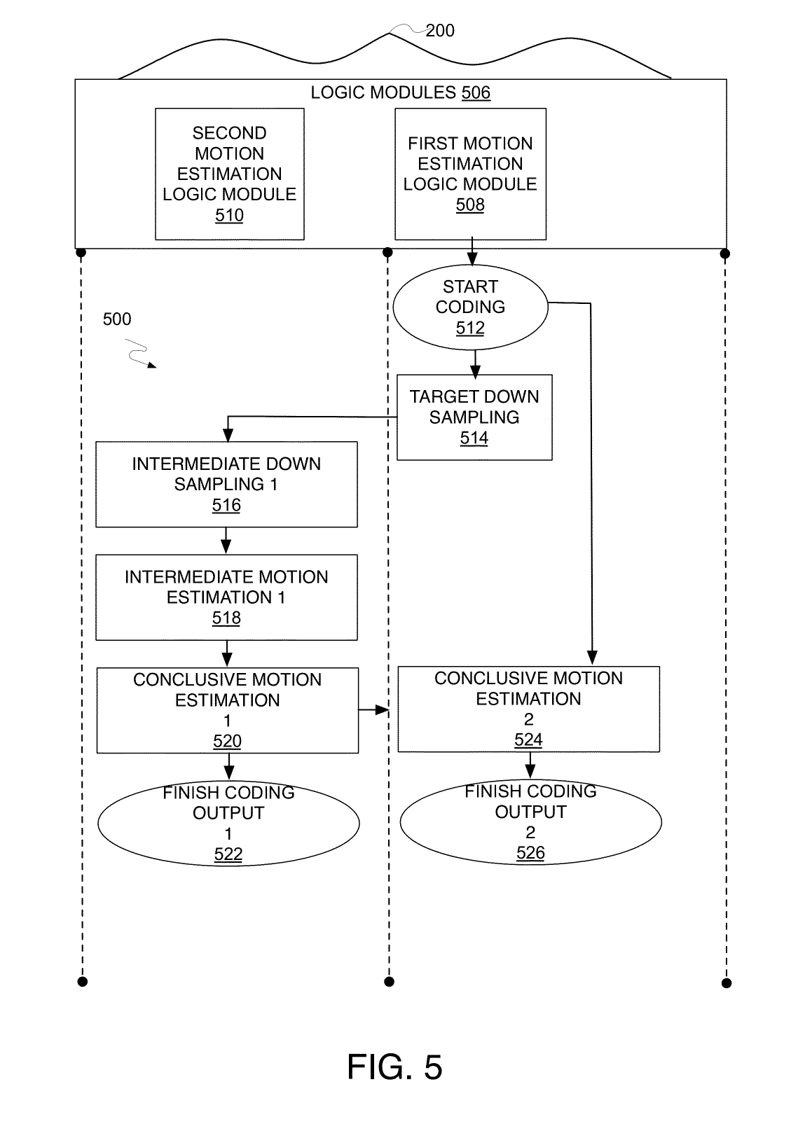

Some additional and/or alternative details related to process 400 may be illustrated in one or more examples of implementations discussed in greater detail below with regard to FIG. 5.

FIG. 5 is an illustrative diagram of example video coding system 200 and video coding process 500 in operation, arranged in accordance with at least some implementations of the present disclosure. In the illustrated implementation, process 500 may include one or more operations, functions or actions as illustrated by one or more of actions 512, 514, 516, 518, 520, 522, 524, and/or 526. By way of non-limiting example, process 500 will be described herein with reference to example video coding system 200 of FIG. 2, 3 and/or 6.

In the illustrated implementation, video coding system 200 may include logic modules 506, the like, and/or combinations thereof. For example, logic modules 506, may include first motion estimation logic module 508, second motion estimation logic module 510, the like, and/or combinations thereof. Although video coding system 200, as shown in FIG. 5, may include one particular set of blocks or actions associated with particular modules, these blocks or actions may be associated with different modules than the particular module illustrated here.

Process 500 may begin at block 512, “START CODING”, where coding may be started. Although process 500, as illustrated, is directed to encoding, the concepts and/or operations described may be applied in the same or similar manner to coding in general, including in decoding.

In cases where a second independent coding stream is being coded, processing may continue from operation 512 to operation 514, “TARGET DOWN SAMPLING”, otherwise, in cases where a first independent coding stream is being coded, processing may continue from operation 512 to operation 524, “CONCLUSIVE MOTION ESTIMATION 2”.

Processing may continue from operation 512 to operation 514, “TARGET DOWN SAMPLING”, where a target down sampling may be performed. For example, target down sampling may be performed from the original video source to the target video source to provide the target video source. The target down sampling may be performed prior to the performance of the conclusive motion estimation of the target video source.

Processing may continue from operation 516 to operation 518, “INTERMEDIATE DOWN SAMPLING 1”, where an intermediate down sampling may be performed. For example, intermediate down sampling may be performed from the target video source to an intermediate video

Processing may continue from operation 516 to operation 518, “INTERMEDIATE MOTION ESTIMATION 1”, where an intermediate motion estimation may be performed. For example, intermediate motion estimation may be performed based at least in part on the intermediate video. In some examples, the intermediate motion estimation may be performed only on full integer pixel point resolution of the intermediate video and not on a fractional pixel point resolution, while the conclusive motion estimation of the target video source may be performed on a fractional pixel point resolution,

Processing may continue from operation 518 to operation 520, “CONCLUSIVE MOTION ESTIMATION 1”, where conclusive motion estimation of a target video source may be performed. For example, conclusive motion estimation of a target video source may be performed within a second independent coding stream, where the target video source may be a down sampled version of an original video source. The original video source may be associated with a first independent coding stream and the target video source may be associated with a second independent coding stream. In some examples, the conclusive motion estimation of the target video source performed during the coding of the second independent coding stream may be based at least in part on the intermediate motion estimation,

Processing may continue from operation 520 to operation 522, “FINISH CODING OUTPUT 1”, where the output from second independent coding stream may be entropy coded.

Processing may additionally or alternatively continue from operation 520 to operation 524, “CONCLUSIVE MOTION ESTIMATION 2”, where conclusive motion estimation of the original video source may be performed. For example, conclusive motion estimation of a the original video source may be performed within the first independent coding stream based at least in part on the conclusive motion estimation of the target video source within the second independent coding stream.

Processing may continue from operation 524 to operation 526, “FINISH CODING OUTPUT 2”, where the output from first independent coding stream may be entropy coded.

In operation, process 500 (and/or 400) may operate so that output from the second independent coding stream may be entropy coded for inclusion in a multi-stream simulcast to generate a coded second output from the target video source based at least in part on the performed conclusive motion estimation for the conclusive motion estimation of the target video source. Similarly, output from the first independent coding stream may be entropy coded for inclusion in the multi-stream simulcast to generate a coded first output from the original video source based at least in part on the performed conclusive motion estimation for the original video source. In some examples, the first independent coding stream may be coded in accordance with a first coding standard, while the second independent coding stream may be coded in accordance with a second coding standard different from the first coding standard associated with the first independent coding stream. For example, the second coded output may have the same resolution as the first coded output and a bandwidth requirement different from the first coded output, or the second coded output may have a resolution different from the first coded output and the same bandwidth requirement as the first coded output.

The proposed optimization would reduce some of the down-sampling process and reuse the lower layer motion estimation results. Specifically, for the example above, if we choose the down-sampled resolution of first stream to be same as the resolution of second stream, down-sampling processes that might have been done independent of one another can be combined into one down-sampling process, and the process of intermediate motion estimation can be eliminated from the first independent coding stream by reusing results from the second independent coding stream. In an example with a two-stream simulcast scenario, at least one down-sampling and one motion estimation can be saved from the whole process, which alone could save up to one third of a computational intensive procedure. This optimization could potentially save computation power, reduce memory bandwidth as well as producing more encoding throughput from encoder.

While implementation of example processes 400 and 500, as illustrated in FIGS. 4 and 5, may include the undertaking of all blocks shown in the order illustrated, the present disclosure is not limited in this regard and, in various examples, implementation of processes 400 and 500 may include the undertaking only a subset of the blocks shown and/or in a different order than illustrated.

In addition, any one or more of the blocks of FIGS. 4 and 5 may be undertaken in response to instructions provided by one or more computer program products. Such program products may include signal bearing media providing instructions that, when executed by, for example, a processor may provide the functionality described herein. The computer program products may be provided in any form of computer readable medium. Thus, for example, a processor including one or more processor core(s) may undertake one or more of the blocks shown in FIGS. 4 and 5 in response to instructions conveyed to the processor by a computer readable medium.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

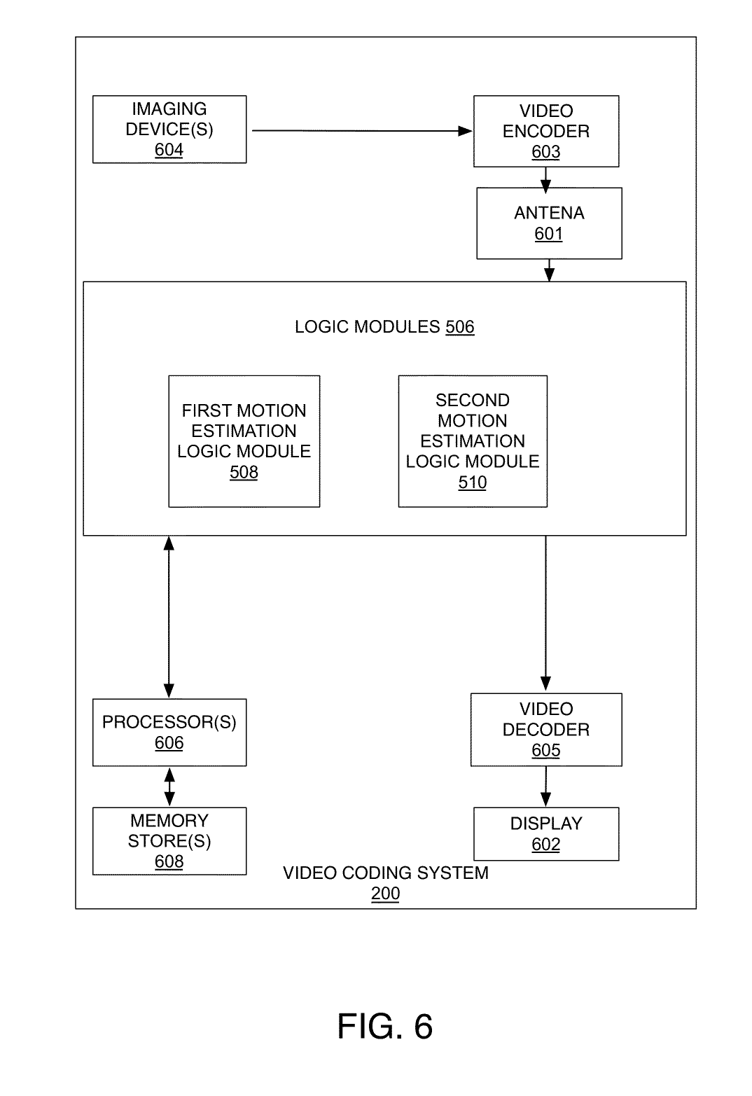

FIG. 6 is an illustrative diagram of an example video coding system 200, arranged in accordance with at least some implementations of the present disclosure. In the illustrated implementation, video coding system 200 may include antenna 601, display 602, imaging device(s) 604, video encoder 603, video decoder 605, and/or logic modules 506. Logic modules 506 may include first motion estimation logic module 508, second motion estimation logic module 510, the like, and/or combinations thereof.

As illustrated, antenna 601, video decoder 605, processor 606, memory store 608, and/or display 602 may be capable of communication with one another and/or communication with portions of logic modules 506. Similarly, imaging device(s) 604 and video encoder 603 may be capable of communication with one another and/or communication with portions of logic modules 506. Accordingly, video decoder 605 may include all or portions of logic modules 506, while video encoder 603 may include similar logic modules. Although video coding system 200, as shown in FIG. 6, may include one particular set of blocks or actions associated with particular modules, these blocks or actions may be associated with different modules than the particular module illustrated here.

In some examples, video coding system 200 may include antenna 601, video decoder 605, the like, and/or combinations thereof. Antenna 601 may be configured to receive an encoded bitstream of video data. Video decoder 605 may be communicatively coupled to antenna 603 and may be configured to decode the encoded bitstream.

In some examples, display device 602 may be configured to present video data. Processors 606 may be communicatively coupled to display device 602. Memory stores 608 may be communicatively coupled to processors 606. Second motion logic module 510 may be communicatively coupled to processors 606 and may be configured to perform conclusive motion estimation of a target video source within a second independent coding stream. The target video source may be a down sampled version of an original video source, where the original video source may be associated with a first independent coding stream and the target video source may be associated with a second independent coding stream. First motion logic module 508 may be communicatively coupled to second motion logic module 510 and may be configured to perform conclusive motion estimation for the original video source within the first independent coding stream based at least in part on the conclusive motion estimation of the target video source within the second independent coding stream. One or more entropy coder modules (not illustrated, see FIG. 3, for example) may be communicatively coupled to first motion logic module 508 and second logic module 510 and may be configured to code output from the second independent coding stream for inclusion in a multi-stream simulcast to generate a coded second output from the target video source based at least in part on the performed conclusive motion estimation for the conclusive motion estimation of the target video source, and code output from the first independent coding stream for inclusion in the multi-stream simulcast to generate a coded first output from the original video source based at least in part on the performed conclusive motion estimation for the original video source.

In some examples, antenna 601 may be configured to receive an encoded bitstream of video data. Video decoder 605 may be communicatively coupled to the antenna and may be configured to decode the encoded bitstream. Video decoder 605 may be configured to perform conclusive motion estimation of a target video source within a second independent coding stream, where the target video source may be a down sampled version of an original video source, where the original video source may be associated with a first independent coding stream and the target video source may be associated with a second independent coding stream. Video decoder 605 may be configured to perform conclusive motion estimation for the original video source within the first independent coding stream based at least in part on the conclusive motion estimation of the target video source within the second independent coding stream. Video decoder 605 may be configured to code output from the second independent coding stream based at least in part on the performed conclusive motion estimation for the conclusive motion estimation of the target video source, and code output from the first independent coding stream based at least in part on the performed conclusive motion estimation for the original video source.

In various embodiments, first motion estimation logic module 508 and/or second motion estimation logic module 510 may be implemented in hardware, while software may implement other logic modules. For example, in some embodiments, first motion estimation logic module 508 and/or second motion estimation logic module 510 may be implemented by application-specific integrated circuit (ASIC) logic while other logic modules may be provided by software instructions executed by logic such as processors 606. However, the present disclosure is not limited in this regard and any of first motion estimation logic module 508, second motion estimation logic module 510, and/or other logic modules may be implemented by any combination of hardware, firmware and/or software. In addition, memory stores 608 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory stores 608 may be implemented by cache memory. In various examples, system 200 may be implemented as a chipset or as a system on a chip.

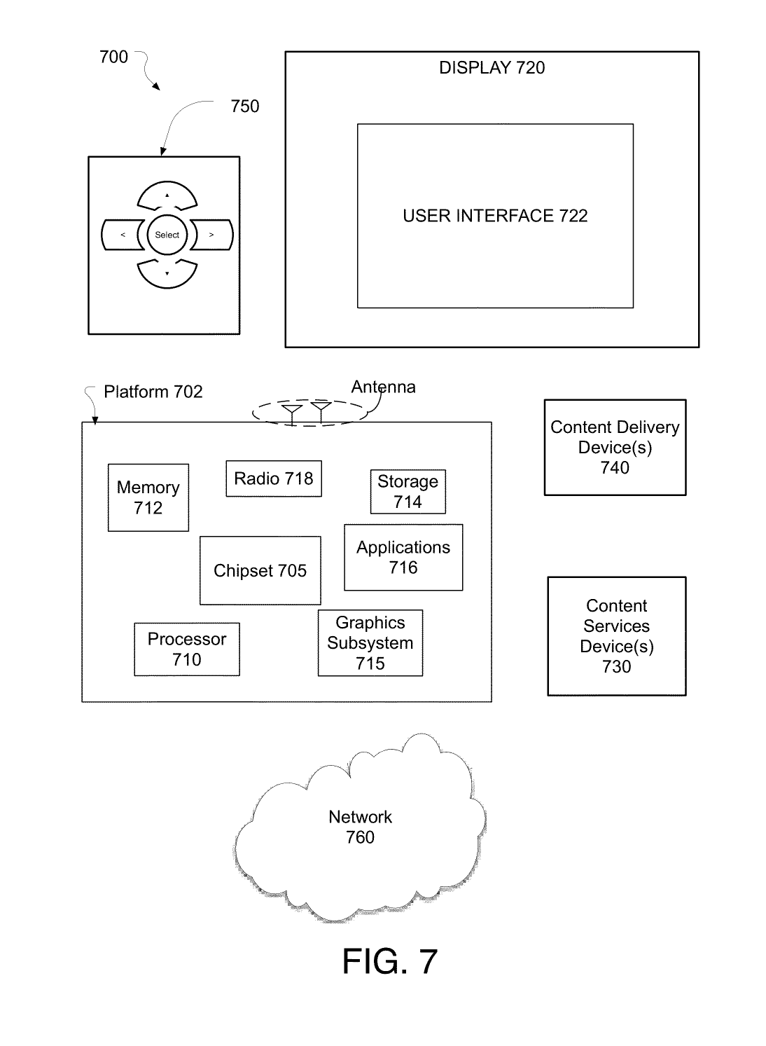

FIG. 7 illustrates an example system 700 in accordance with the present disclosure. In various implementations, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 700 includes a platform 702 coupled to a display 720. Platform 702 may receive content from a content device such as content services device(s) 730 or content delivery device(s) 740 or other similar content sources. A navigation controller 750 including one or more navigation features may be used to interact with, for example, platform 702 and/or display 720. Each of these components is described in greater detail below.

In various implementations, platform 702 may include any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 710 may be dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 714 may include technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, Display Port, wireless HDMI, and/or wireless HD compliant techniques. Graphics subsystem 715 may be integrated into processor 710 or chipset 705. In some implementations, graphics subsystem 715 may be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 718 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In various implementations, display 720 may include any television type monitor or display. Display 720 may include, for example, a computer display screen, touch screen display, video monitor, television-like device, and/or a television. Display 720 may be digital and/or analog. In various implementations, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In various implementations, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In various implementations, content services device(s) 730 may include a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be replicated on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but may be integrated into platform 702 and/or display 720. The present disclosure, however, is not limited to the elements or in the context shown or described herein.

In various implementations, drivers (not shown) may include technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 even when the platform is turned “off” In addition, chipset 705 may include hardware and/or software support for (6.1) surround sound audio and/or high definition (7.1) surround sound audio, for example. Drivers may include a graphics driver for integrated graphics platforms. In embodiments, the graphics driver may include a peripheral component interconnect (PCI) Express graphics card.

In various implementations, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the present disclosure.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 7.

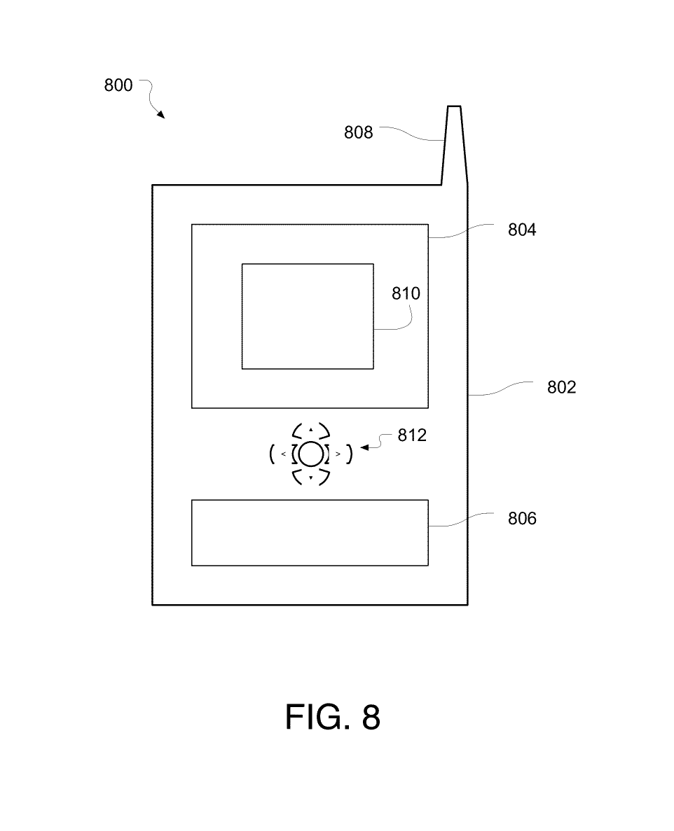

As described above, system 700 may be embodied in varying physical styles or form factors. FIG. 8 illustrates implementations of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 8, device 800 may include a housing 802, a display 804, an input/output (I/O) device 806, and an antenna 808. Device 800 also may include navigation features 812. Display 804 may include any suitable display unit for displaying information appropriate for a mobile computing device. I/O device 806 may include any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The above examples may include specific combination of features. However, such the above examples are not limited in this regard and, in various implementations, the above examples may include the undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

What is claimed:

1. A computer-implemented method for video coding, comprising:
performing conclusive motion estimation of a target video source within a second independent coding stream, wherein the target video source is a down sampled version of an original video source, wherein the original video source is associated with a first independent coding stream and the target video source is associated with a second independent coding stream; and
performing conclusive motion estimation for the original video source within the first independent coding stream based at least in part on the conclusive motion estimation of the target video source within the second independent coding stream.

2. The method of claim 1, further comprising:
performing a target down sampling from the original video source to the target video source to provide the target video source, wherein the target down sampling is performed prior to the performance of the conclusive motion estimation of the target video source.

3. The method of claim 1, further comprising:
coding output from the second independent coding stream for inclusion in a multi-stream simulcast to generate a coded second output from the target video source based at least in part on the performed conclusive motion estimation for the conclusive motion estimation of the target video source; and
coding output from the first independent coding stream for inclusion in the multi-stream simulcast to generate a coded first output from the original video source based at least in part on the performed conclusive motion estimation for the original video source.

4. The method of claim 1, further comprising:
coding output from the second independent coding stream for inclusion in a multi-stream simulcast to generate a coded second output from the target video source based at least in part on the performed conclusive motion estimation for the conclusive motion estimation of the target video source; and
coding output from the first independent coding stream for inclusion in the multi-stream simulcast to generate a coded first output from the original video source based at least in part on the performed conclusive motion estimation for the original video source,
wherein the first independent coding stream is coded in accordance with a first coding standard, and wherein the second independent coding stream is coded in accordance with a second coding standard different from the first coding standard associated with the first independent coding stream.

5. The method of claim 1, further comprising:
coding output from the second independent coding stream for inclusion in a multi-stream simulcast to generate a coded second output from the target video source based at least in part on the performed conclusive motion estimation for the conclusive motion estimation of the target video source; and
coding output from the first independent coding stream for inclusion in the multi-stream simulcast to generate a coded first output from the original video source based at least in part on the performed conclusive motion estimation for the original video source,
wherein the second coded output has the same resolution as the first coded output and a bandwidth requirement different from the first coded output.

6. The method of claim 1, further comprising:
coding output from the second independent coding stream for inclusion in a multi-stream simulcast to generate a coded second output from the target video source based at least in part on the performed conclusive motion estimation for the conclusive motion estimation of the target video source; and
coding output from the first independent coding stream for inclusion in the multi-stream simulcast to generate a coded first output from the original video source based at least in part on the performed conclusive motion estimation for the original video source,
wherein the second coded output has a resolution different from the first coded output and the same bandwidth requirement as the first coded output.

7. The method of claim 1, wherein the conclusive motion estimation of the target video source is performed on a fractional pixel point resolution.

8. The method of claim 1, wherein the coding of the second independent coding stream further comprises:
performing an intermediate down sampling from the target video source to an intermediate video; and
performing an intermediate motion estimation based at least in part on the intermediate video, wherein the intermediate motion estimation is performed only on full integer pixel point resolution of the intermediate video and not on a fractional pixel point resolution,
wherein the conclusive motion estimation of the target video source performed during the coding of the second independent coding stream is based at least in part on the intermediate motion estimation.

9. The method of claim 1, further comprising:
performing a target down sampling from the original video source to the target video source to provide the target video source, wherein the target down sampling is performed prior to the performance of the conclusive motion estimation of the target video source;
wherein the coding of the second independent coding stream further comprises:
performing an intermediate down sampling from the target video source to an intermediate video; and
performing an intermediate motion estimation based at least in part on the intermediate video, wherein the intermediate motion estimation is performed only on full integer pixel point resolution of the intermediate video and not on a fractional pixel point resolution, wherein the conclusive motion estimation of the target video source is performed on a fractional pixel point resolution,
wherein the conclusive motion estimation of the target video source performed during the coding of the second independent coding stream is based at least in part on the intermediate motion estimation,
coding output from the second independent coding stream for inclusion in a multi-stream simulcast to generate a coded second output from the target video source based at least in part on the performed conclusive motion estimation for the conclusive motion estimation of the target video source; and
coding output from the first independent coding stream for inclusion in the multi-stream simulcast to generate a coded first output from the original video source based at least in part on the performed conclusive motion estimation for the original video source,
wherein the first independent coding stream is coded in accordance with a first coding standard, and wherein the second independent coding stream is coded in accordance with a second coding standard different from the first coding standard associated with the first independent coding stream,
wherein the second coded output has the same resolution as the first coded output and a bandwidth requirement different from the first coded output or the second coded output has a resolution different from the first coded output and the same bandwidth requirement as the first coded output.

10. A system for video coding on a computer, comprising:
a display device configured to present video data;
one or more processors communicatively coupled to the display device;
one or more memory stores communicatively coupled to the one or more processors;
a second motion logic module communicatively coupled to the one or more processors and configured to perform conclusive motion estimation of a target video source within a second independent coding stream, wherein the target video source is a down sampled version of an original video source, wherein the original video source is associated with a first independent coding stream and the target video source is associated with a second independent coding stream;
a first motion logic module communicatively coupled to the second motion logic module and configured to perform conclusive motion estimation for the original video source within the first independent coding stream based at least in part on the conclusive motion estimation of the target video source within the second independent coding stream; and
one or more entropy coder modules communicatively coupled to the first motion logic module and the second logic module and configured to:
code output from the second independent coding stream for inclusion in a multi-stream simulcast to generate a coded second output from the target video source based at least in part on the performed conclusive motion estimation for the conclusive motion estimation of the target video source, and
code output from the first independent coding stream for inclusion in the multi-stream simulcast to generate a coded first output from the original video source based at least in part on the performed conclusive motion estimation for the original video source.

11. The system of claim 10, further comprising:
a target down sampling logic module configured to perform a target down sampling from the original video source to the target video source to provide the target video source, wherein the target down sampling is performed prior to the performance of the conclusive motion estimation of the target video source.

12. The system of claim 10, wherein the first independent coding stream is coded in accordance with a first coding standard, and wherein the second independent coding stream is coded in accordance with a second coding standard different from the first coding standard associated with the first independent coding stream.

13. The system of claim 10, wherein the second coded output has the same resolution as the first coded output and a bandwidth requirement different from the first coded output.

14. The system of claim 10, wherein the second coded output has a resolution different from the first coded output and the same bandwidth requirement as the first coded output.

15. The system of claim 15, wherein the conclusive motion estimation of the target video source is performed on a fractional pixel point resolution.

16. The system of claim 10, further comprising:
an intermediate down sampling logic module configured to perform an intermediate down sampling from the target video source to an intermediate video; and
an intermediate motion logic module communicatively coupled to the intermediate down sampling logic module and configured to perform an intermediate motion estimation based at least in part on the intermediate video, wherein the intermediate motion estimation is performed only on full integer pixel point resolution of the intermediate video and not on a fractional pixel point resolution,
wherein the conclusive motion estimation of the target video source performed during the coding of the second independent coding stream is based at least in part on the intermediate motion estimation.

17. The system of claim 10, further comprising:
a target down sampling logic module configured to perform a target down sampling from the original video source to the target video source to provide the target video source, wherein the target down sampling is performed prior to the performance of the conclusive motion estimation of the target video source; and
an intermediate down sampling logic module communicatively coupled to the target down sampling logic module and configured to perform an intermediate down sampling from the target video source to an intermediate video;
an intermediate motion logic module communicatively coupled to the intermediate down sampling logic module and configured to perform an intermediate motion estimation based at least in part on the intermediate video, wherein the intermediate motion estimation is performed only on full integer pixel point resolution of the intermediate video and not on a fractional pixel point resolution,
wherein the conclusive motion estimation of the target video source performed during the coding of the second independent coding stream is based at least in part on the intermediate motion estimation,
wherein the first independent coding stream is coded in accordance with a first coding standard, and wherein the second independent coding stream is coded in accordance with a second coding standard different from the first coding standard associated with the first independent coding stream,
wherein the second coded output has the same resolution as the first coded output and a bandwidth requirement different from the first coded output or the second coded output has a resolution different from the first coded output and the same bandwidth requirement as the first coded output.

18. A system comprising:
an antenna configured to receive an encoded bitstream of video data; and
a video decoder communicatively coupled to the antenna and configured to decode the encoded bitstream, wherein the video decoder is configured to:
perform conclusive motion estimation of a target video source within a second independent coding stream, wherein the target video source is a down sampled version of an original video source, wherein the original video source is associated with a first independent coding stream and the target video source is associated with a second independent coding stream;
perform conclusive motion estimation for the original video source within the first independent coding stream based at least in part on the conclusive motion estimation of the target video source within the second independent coding stream; and
code output from the second independent coding stream based at least in part on the performed conclusive motion estimation for the conclusive motion estimation of the target video source; and
code output from the first independent coding stream based at least in part on the performed conclusive motion estimation for the original video source.

19. The system of claim 18, wherein the video decoder is configured to:
perform a target down sampling from the original video source to the target video source to provide the target video source, wherein the target down sampling is performed prior to the performance of the conclusive motion estimation of the target video source.

20. The system of claim 18, wherein the first independent coding stream is coded in accordance with a first coding standard, and wherein the second independent coding stream is coded in accordance with a second coding standard different from the first coding standard associated with the first independent coding stream.

21. The system of claim 18, wherein the second coded output has the same resolution as the first coded output and a bandwidth requirement different from the first coded output.

22. The system of claim 18, wherein the second coded output has a resolution different from the first coded output and the same bandwidth requirement as the first coded output.

23. The system of claim 18, wherein the conclusive motion estimation of the target video source is performed on a fractional pixel point resolution.

24. The system of claim 18, wherein the video decoder is configured to:
perform an intermediate down sampling from the target video source to an intermediate video; and
perform an intermediate motion estimation based at least in part on the intermediate video, wherein the intermediate motion estimation is performed only on full integer pixel point resolution of the intermediate video and not on a fractional pixel point resolution,
wherein the conclusive motion estimation of the target video source performed during the coding of the second independent coding stream is based at least in part on the intermediate motion estimation.

25. The system of claim 18, wherein the video decoder is configured to:
perform a target down sampling from the original video source to the target video source to provide the target video source, wherein the target down sampling is performed prior to the performance of the conclusive motion estimation of the target video source; and
perform an intermediate down sampling from the target video source to an intermediate video;
perform an intermediate motion estimation based at least in part on the intermediate video, wherein the intermediate motion estimation is performed only on full integer pixel point resolution of the intermediate video and not on a fractional pixel point resolution,
wherein the conclusive motion estimation of the target video source performed during the coding of the second independent coding stream is based at least in part on the intermediate motion estimation,
wherein the first independent coding stream is coded in accordance with a first coding standard, and wherein the second independent coding stream is coded in accordance with a second coding standard different from the first coding standard associated with the first independent coding stream,
wherein the second coded output has the same resolution as the first coded output and a bandwidth requirement different from the first coded output or the second coded output has a resolution different from the first coded output and the same bandwidth requirement as the first coded output.

26. An article for video coding on a computer comprising a computer program product having stored therein instructions that, if executed, result in:
performing conclusive motion estimation of a target video source within a second independent coding stream, wherein the target video source is a down sampled version of an original video source, wherein the original video source is associated with a first independent coding stream and the target video source is associated with a second independent coding stream; and
performing conclusive motion estimation for the original video source within the first independent coding stream based at least in part on the conclusive motion estimation of the target video source within the second independent coding stream.

27. The article of claim 26, further comprising:
performing a target down sampling from the original video source to the target video source to provide the target video source, wherein the target down sampling is performed prior to the performance of the conclusive motion estimation of the target video source;
wherein the coding of the second independent coding stream further comprises:
performing an intermediate down sampling from the target video source to an intermediate video; and
performing an intermediate motion estimation based at least in part on the intermediate video, wherein the intermediate motion estimation is performed only on full integer pixel point resolution of the intermediate video and not on a fractional pixel point resolution, wherein the conclusive motion estimation of the target video source is performed on a fractional pixel point resolution,
wherein the conclusive motion estimation of the target video source performed during the coding of the second independent coding stream is based at least in part on the intermediate motion estimation,
coding output from the second independent coding stream for inclusion in a multi-stream simulcast to generate a coded second output from the target video source based at least in part on the performed conclusive motion estimation for the conclusive motion estimation of the target video source; and
coding output from the first independent coding stream for inclusion in the multi-stream simulcast to generate a coded first output from the original video source based at least in part on the performed conclusive motion estimation for the original video source,
wherein the first independent coding stream is coded in accordance with a first coding standard, and wherein the second independent coding stream is coded in accordance with a second coding standard different from the first coding standard associated with the first independent coding stream,
wherein the second coded output has the same resolution as the first coded output and a bandwidth requirement different from the first coded output or the second coded output has a resolution different from the first coded output and the same bandwidth requirement as the first coded output.

28. An apparatus, comprising:
means for performing conclusive motion estimation of a target video source within a second independent coding stream, wherein the target video source is a down sampled version of an original video source, wherein the original video source is associated with a first independent coding stream and the target video source is associated with a second independent coding stream; and
means for performing conclusive motion estimation for the original video source within the first independent coding stream based at least in part on the conclusive motion estimation of the target video source within the second independent coding stream.

29. The apparatus of claim 28, further comprising:
means for performing a target down sampling from the original video source to the target video source to provide the target video source, wherein the target down sampling is performed prior to the performance of the conclusive motion estimation of the target video source;
means for performing an intermediate down sampling from the target video source to an intermediate video;
means for performing an intermediate motion estimation based at least in part on the intermediate video, wherein the intermediate motion estimation is performed only on full integer pixel point resolution of the intermediate video and not on a fractional pixel point resolution, wherein the conclusive motion estimation of the target video source is performed on a fractional pixel point resolution, wherein the conclusive motion estimation of the target video source performed during the coding of the second independent coding stream is based at least in part on the intermediate motion estimation;
means for coding output from the second independent coding stream for inclusion in a multi-stream simulcast to generate a coded second output from the target video source based at least in part on the performed conclusive motion estimation for the conclusive motion estimation of the target video source; and
means for coding output from the first independent coding stream for inclusion in the multi-stream simulcast to generate a coded first output from the original video source based at least in part on the performed conclusive motion estimation for the original video source,
wherein the first independent coding stream is coded in accordance with a first coding standard, and wherein the second independent coding stream is coded in accordance with a second coding standard different from the first coding standard associated with the first independent coding stream,
wherein the second coded output has the same resolution as the first coded output and a bandwidth requirement different from the first coded output or the second coded output has a resolution different from the first coded output and the same bandwidth requirement as the first coded output.
